(19) United States
(12) Patent Application Publication
(10) Pub. No.: US 2025/0232740 A1
(43) Pub. Date: Jul. 17, 2025

(54) DISPLAY DEVICE

(71) Applicant: Japan Display Inc., Tokyo (JP)

(72) Inventor: Hitoshi TANAKA, Tokyo (JP)

(21) Appl. No.: 19/011,893

(22) Filed: Jan. 7, 2025

(30) Foreign Application Priority Data
Jan. 11, 2024 (JP) 2024-002283

(51) Int. Cl. G09G 3/36

(52) U.S. Cl. CPC G09G 3/3607; G09G 3/3648; G09G 2300/0452; G09G 2310/08; G09G 2320/0242

(57) ABSTRACT

A display device includes: pixels, gate lines, signal lines, and a drive circuit. When M is the total number of the pixels arrayed in ascending order from a first column to a m-th column (m is a natural number) from one end in a first direction to the other end, and N is the total number of the pixels arrayed in ascending order from a first row to a n-th row (n is a natural number) from one end in a second direction to the other end, the total number of the gate lines is N, and the total number of the signal lines is M+1, the n-th gate line is coupled to the pixels arrayed in the n-th row, and the m-th signal line is coupled to the pixels arrayed in the m−1-th column of odd-numbered rows and the pixels arrayed in the m-th column of even-numbered rows.

### CROSS-REFERENCE TO RELATED APPLICATION

This application claims the benefit of priority from Japanese Patent Application No. 2024-002283 filed on Jan. 11, 2024, the entire contents of which are incorporated herein by reference.

### BACKGROUND

### 1. Technical Field

The present disclosure relates to a display device.

### 2. Description of the Related Art

In recent years, display panels have been required to achieve higher definition in a configuration that magnifies and displays images by a lens, such as virtual reality (VR), augmented reality (AR), and mixed reality (MR). Conventionally, to achieve a high frame rate in such a high-definition panel, there have been disclosed display devices that can simultaneously drive a set of adjacent gate lines.

In a typical pixel configuration of a square-shaped RGB stripe array, the width of sub-pixels R, G, and B in the array direction is narrower, making it difficult to secure the opening area. To address this, there have been disclosed pixel configurations that facilitate securing the opening area of the sub-pixels R, G, and B with the same pixel area as the pixel configuration of the RGB stripe array. The pixel array can achieve higher definition than the pixel configuration of the RGB stripe array.

In the pixel array, the colors of sub-pixels adjacent in the array direction of the gate lines are different. The sub-pixels of different colors are coupled to a common signal line. A display device with such a pixel configuration fails to simultaneously drive a set of adjacent gate lines.

For the foregoing reasons, there is a need for a display device that can simultaneously drive a set of adjacent gate lines in a pixel configuration where the colors of sub-pixels adjacent in the array direction of the gate lines are different.

### SUMMARY

According to an aspect, a display device includes: a plurality of pixels arrayed in a matrix having a row-column configuration in a first direction and a second direction intersecting the first direction of a display region, a plurality of gate lines extending in the first direction and arrayed in the second direction, a plurality of signal lines extending in the second direction and arrayed in the first direction, and a drive circuit configured to supply a pixel signal to the pixels via the signal lines and drive the pixels via the gate lines. When M is the total number of the pixels arrayed in ascending order from the first column to the m-th column (m is a natural number) from one end in the first direction to the other end, and N is the total number of the pixels arrayed in ascending order from the first row to the n-th row (n is a natural number) from one end in the second direction to the other end, the total number of the gate lines is N, and the total number of the signal lines is M+1, the n-th gate line is coupled to the pixels arrayed in the n-th row of the respective columns, and the m-th signal line is coupled to the pixels arrayed in the m−1-th column of odd-numbered rows and the pixels arrayed in the m-th column of even-numbered rows.

### BRIEF DESCRIPTION OF THE DRAWINGS

FIG. 1 is a diagram of an example of a schematic configuration of a display device according to an embodiment;

FIG. 2 is a diagram of an example of a pixel configuration in a display region;

FIG. 3 is a sectional view of a schematic sectional structure of the display device;

FIG. 4 is a block diagram of an exemplary configuration of a gate driver;

FIG. 5 is a circuit diagram of an example of the circuit configuration of a shift register circuit;

FIG. 6 is a circuit diagram of an example of the circuit configuration of a gate line drive circuit;

FIG. 7 is a timing chart of a first drive example of the display device according to the embodiment;

FIG. 8 is a timing chart of a second drive example of the display device according to the embodiment; and

FIG. 9 is a diagram of an example of a schematic configuration of the display device according to a comparative example.

### DETAILED DESCRIPTION

The following describes modes (embodiments) for carrying out the invention in detail with reference to the drawings. The present invention is not limited to the description of the embodiments to be given below. Components to be described below include those easily conceivable by those skilled in the art or those substantially identical thereto. In addition, the components to be described below can be combined as appropriate. What is disclosed herein is merely an example, and the present invention naturally encompasses appropriate modifications easily conceivable by those skilled in the art while maintaining the gist of the invention. To further clarify the description, the drawings schematically illustrate, for example, widths, thicknesses, and shapes of various parts as compared with actual aspects thereof, in some cases. However, they are merely examples, and interpretation of the present invention is not limited thereto. The same element as that illustrated in a drawing that has already been discussed is denoted by the same reference numeral through the description and the drawings, and detailed description thereof will not be repeated in some cases where appropriate.

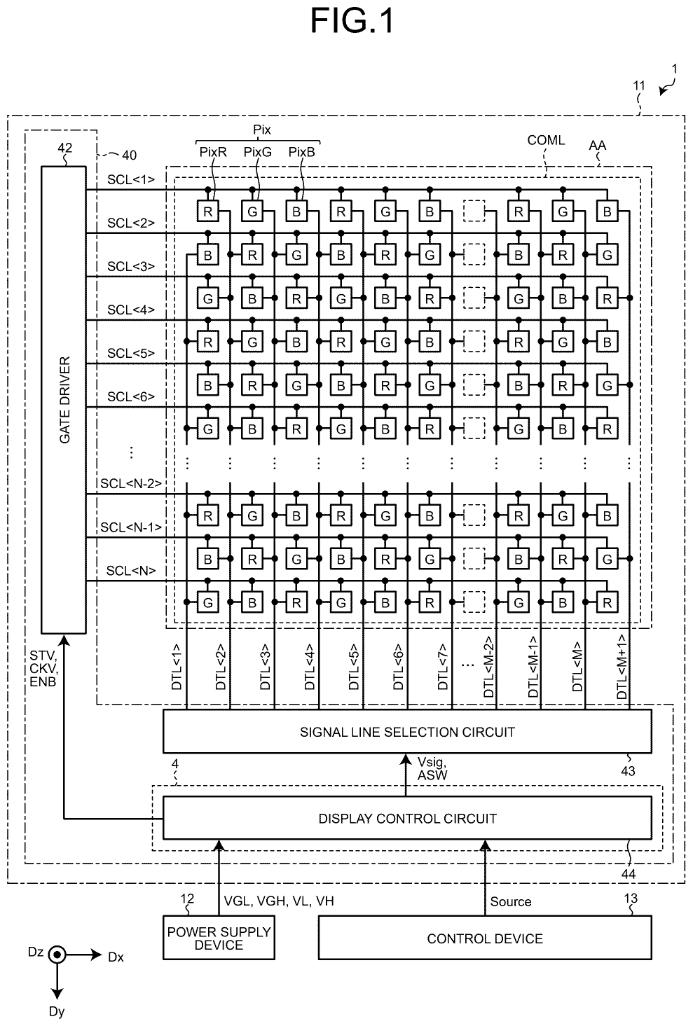

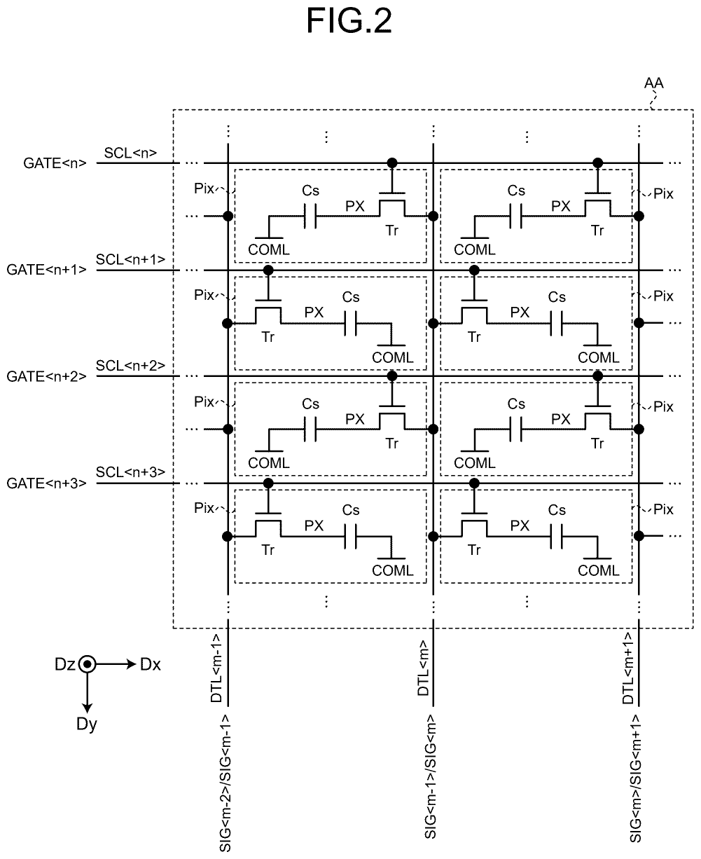

FIG. 1 is a diagram of an example of a schematic configuration of a display device according to an embodiment. FIG. 2 is a diagram of an example of a pixel configuration in a display region.

A display device 1 according to the present embodiment is, for example, a liquid crystal display device provided with liquid crystal display elements as display elements. The display device 1 according to the present disclosure can employ a column inversion driving method or a frame inversion driving method, for example, as a driving method. The driving method in the display device 1 is not limited to the column inversion driving method or the frame inversion driving method.

The display device 1 has a display region AA on a display panel 11, and a drive circuit 40 is provided in a peripheral region of the display region AA. The display device 1 is supplied with electric power from a power supply device 12.

The drive circuit 40 includes a gate driver 42, a signal line selection circuit 43, and a display control circuit 44. The gate driver 42 and the signal line selection circuit 43 are thin-film transistor (TFT) circuits formed in the peripheral region of the display region AA. The display control circuit 44 is included in a driver IC 4 mounted in the peripheral region of the display region AA. The driver IC 4 is coupled to a control device 13 via a relay substrate composed of flexible printed circuits (FPC), for example.

The control device 13 controls power supply from the power supply device 12 to the display device 1. The control device 13 also controls power-on and power-off of the display device 1. The power supply device 12 and the control device 13 are mounted on an apparatus (not illustrated) provided with the display device 1, for example.

The display region AA is provided with a plurality of pixels Pix arrayed in a Dx direction (first direction) and a Dy direction (second direction). The display region AA is also provided with gate lines SCL, signal lines DTL, and a common electrode COML. The gate line SCL supplies gate signals GATE to the pixels Pix. The signal line DTL supplies pixel signals SIG to the pixels Pix. The common electrode COML supplies a common potential VCOM to the pixels Pix. The gate line SCL according to the present embodiment is provided extending in the Dx direction (first direction). The signal line DTL according to the present embodiment is provided extending in the Dy direction (second direction).

In FIG. 1, M is the total number of pixels Pix arrayed in ascending order from the first column to the m-th column (m is a natural number) from one end in the Dx direction (first direction) to the other end, and N is the total number of pixels Pix arrayed in ascending order from the first row to the n-th row (n is a natural number) from one end in the Dy direction (second direction) to the other end. In the display device 1 according to the embodiment, the total number of gate lines SCL arrayed in the Dy direction (second direction) is N, and the total number of signal lines DTL arrayed in the Dx direction (first direction) is M+1. In the following description, the n-th gate line SCL is also referred to as “gate line SCL<n>”, and the m-th signal line DTL is also referred to as “signal line DTL<m>”.

In the configuration of the display device 1 according to the embodiment illustrated in FIG. 1, the gate line SCL<n> is coupled to the pixels Pix arrayed in the n-th row of the respective columns. The signal line DTL<m> is coupled to the pixels Pix arrayed in the m−1-th column of the odd-numbered rows and the pixels Pix arrayed in the m-th column of the even-numbered rows. In the following description, the pixel Pix provided in the m-th column of the n-th row is also referred to simply as “pixel Pix in the n-th row and m-th column”.

As illustrated in FIG. 2, each pixel Pix includes a pixel transistor Tr and a pixel electrode PX. The pixel transistor Tr is composed of a thin-film transistor (TFT) and is, for example, an n-channel metal oxide semiconductor (MOS) TFT (hereinafter also referred to as “n-type TFT”).

FIG. 2 illustrates the pixels Pix arrayed from the n-th row to the n+3-th row. FIG. 2 also illustrates the pixels Pix arrayed from the m−1-th column to the m-th column.

In FIG. 2, the n-th row (n+2-th row) are the odd-numbered rows, and the n+1-th row (n+3-th row) are the even-numbered rows.

The source of the pixel transistor Tr of the pixel Pix in the n-th row and the m−1-th column is coupled to the signal line DTL<m>, and the gate thereof is coupled to the gate line SCL<n>. The source of the pixel transistor Tr of the pixel Pix in the n+1-th row and the m−1-th column is coupled to the signal line DTL<m−1>, and the gate thereof is coupled to the gate line SCL<n+1>. The source of the pixel transistor Tr of the pixel Pix in the n+2-th row and the m−1-th column is coupled to the signal line DTL<m>, and the gate thereof is coupled to the gate line SCL<n+2>. The source of the pixel transistor Tr of the pixel Pix in the n+3-th row and the m−1-th column is coupled to the signal line DTL<m−1>, and the gate thereof is coupled to the gate line SCL<n+3>.

The source of the pixel transistor Tr of the pixel Pix in the n-th row and the m-th column is coupled to the signal line DTL<m+1>, and the gate thereof is coupled to the gate line SCL<n>. The source of the pixel transistor Tr of the pixel Pix in the n+1-th row and the m-th column is coupled to the signal line DTL<m>, and the gate thereof is coupled to the gate line SCL<n+1>. The source of the pixel transistor Tr of the pixel Pix in the n+2-th row and the m-th column is coupled to the signal line DTL<m+1>, and the gate thereof is coupled to the gate line SCL<n+2>. The source of the pixel transistor Tr of the pixel Pix in the n+3-th row and the m-th column is coupled to the signal line DTL<m>, and the gate thereof is coupled to the gate line SCL<n+3>.

The drain of the pixel transistor Tr of each pixel Pix is coupled to the pixel electrode PX. A holding capacitance Cs is formed between the pixel electrode PX and the common electrode COML.

The gate signals GATE are supplied to the gates of the pixel transistors Tr of the pixels Pix arrayed in the Dx direction (first direction) via the gate line SCL, and the pixel signals SIG are supplied to the sources of the pixel transistors Tr of the pixels Pix arrayed in the Dy direction (second direction) via the signal line DTL. In the following description, the gate signal GATE supplied to the pixels Pix arrayed in the n-th row is also referred to as “gate signal GATE<n>”, and the pixel signal SIG supplied to the pixels Pix arrayed in the m-th column is also referred to as “pixel signal SIG<m>”.

The gate signal GATE<n> is supplied to the pixels Pix arrayed in the n-th row of the respective columns via the gate line SCL<n>.

The common pixel signal SIG<m> is supplied to the pixels Pix arrayed in the m−1-th column of the odd-numbered rows and the pixels Pix arrayed in the m-th column of the even-numbered rows via the signal line DTL<m>.

The pixels Pix according to the present disclosure include, for example, a first pixel PixR for displaying red (R), a second pixel PixG for displaying green (G), and a third pixel PixB for displaying blue (B).

As illustrated in FIG. 1, the first pixel PixR, the second pixel PixG, and the third pixel PixB according to the present disclosure are arrayed in the order of the first pixel PixR, the second pixel PixG, and the third pixel PixB in ascending order in the Dx direction (first direction).

As illustrated in FIG. 1, the first pixel PixR, the second pixel PixG, and the third pixel PixB according to the present disclosure are arrayed in the order of the first pixel PixR, the second pixel PixG, and the third pixel PixB in descending order in the Dy direction (second direction).

In the pixel configuration according to the embodiment described above, the display color of the pixel Pix in the n-th row and the m-th column is different from that of the pixel Pix in the n-th row and the m+1-th column.

In the pixel configuration according to the embodiment described above, the display color of the pixel Pix in the n-th row and the m-th column is different from that of the pixel Pix in the n+1-th row and the m-th column.

In the pixel configuration according to the embodiment described above, the display color of the pixel Pix in the n-th row and the m-th column is the same as that of the pixel Pix in the n+1-th row and the m+1-th column.

The power supply device 12 generates a negative first potential VGL and a positive second potential VGH and supplies them to the display device 1. The first potential VGL is −8 V, for example. The second potential VGH is +8 V, for example. The first potential VGL and the second potential VGH are supplied to the gate driver 42. The first potential VGL supplied to the gate driver 42 is not limited to −8 V. The second potential VGH supplied to the gate driver 42 is not limited to +8 V.

The power supply device 12 also generates a negative third potential VL and a positive fourth potential VH and supplies them to the display device 1. The third potential VL is −5 V, for example. The fourth potential VH is +5 V, for example. The third potential VL and the fourth potential VH are supplied to the driver IC 4. The third potential VL supplied to the driver IC 4 is not limited to −5 V. The fourth potential VH supplied to the driver IC 4 is not limited to +5 V.

The control device 13 transmits video signals Source serving as the original signals of video to be displayed on the display device 1 to the display device 1.

The control device 13 includes, for example, a central processing unit (CPU) and a storage device, such as a memory. The control device 13 can implement the display functions of the display device 1 by executing computer programs using these hardware resources, such as the CPU and the storage device. The control device 13 performs control such that the driver IC 4 can handle the image to be displayed on the display device 1 as the information on image input gradation according to the execution results of the computer programs.

The display control circuit 44 controls the display operation in the display region AA by controlling the gate driver 42 and the signal line selection circuit 43. The display control circuit 44 receives the video signals Source and various control signals from the control device 13. The display control circuit 44 converts the video signals Source received from the control device 13 into image signals Vsig and outputs them. The image signal Vsig is, for example, a signal obtained by time-division multiplexing the pixel signal Sig according to the pixel array of RGB (W). The display control circuit 44 supplies the common potential VCOM to the common electrode COML.

The display control circuit 44 also functions as an interface (I/F) and a timing generator between the signal line selection circuit 43 and the control device 13. The driver IC 4 including the display control circuit 44 may be mounted not on the display panel 11 but on a relay substrate coupled to the display panel 11. The gate driver 42 and the signal line selection circuit 43 may be included in the driver IC 4.

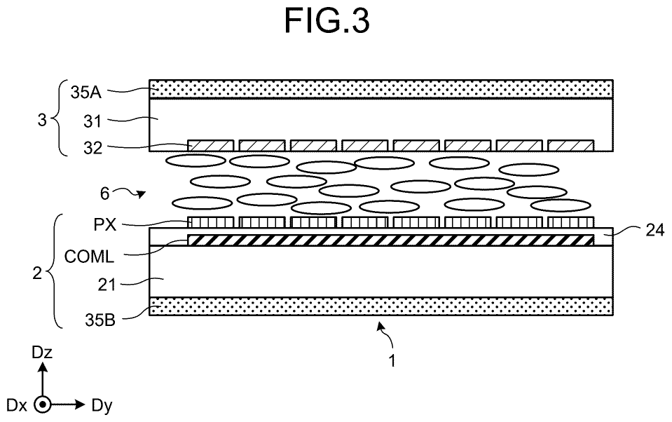

Next, a schematic structure of the display device 1 according to the embodiment is described. FIG. 3 is a sectional view of a schematic sectional structure of the display device.

An array substrate 2 includes a first substrate 21 made of glass or transparent resin, a plurality of pixel electrodes PX, the common electrode COML, and an insulating layer 24 that insulates the pixel electrodes PX from the common electrode COML. The pixel electrodes PX are disposed on the first substrate 21 in a matrix having a row-column configuration, for example. The common electrode COML is provided between the first substrate 21 and the pixel electrodes PX.

The pixel electrodes PX are provided corresponding to the respective pixels Pix. The pixel signal SIG for performing a display operation is supplied from the signal line selection circuit 43 to the pixel electrode PX via the signal line DTL and the pixel transistor Tr. In the display operation, the driver IC 4 supplies the common potential VCOM for display serving as a voltage signal to the common electrode COML. The common potential VCOM is preferably different from the GND potential and is approximately −0.08 V, for example. The common potential VCOM is set to the optimum value that does not cause flicker in the driving method, such as the column inversion driving method and the frame inversion driving method. While the common potential VCOM is preferably a fixed potential, it may have a waveform composed of AC square waves.

The pixel electrode PX and the common electrode COML are composed of light-transmitting conductive material, such as indium tin oxide (ITO). A polarizing plate 35B is provided under the first substrate 21 with an adhesive layer (not illustrated) interposed therebetween.

A counter substrate 3 includes a second substrate 31 made of glass or transparent resin, and color filters 32 and a light-shielding layer (not illustrated) formed on one surface of the second substrate 31. A polarizing plate 35A is provided on the second substrate 31 with an adhesive layer (not illustrated) interposed therebetween.

The color filters 32 are provided corresponding to the respective pixels Pix. Specifically, a red (R) color filter is provided at the position corresponding to the pixel electrode PX of the first pixel PixR. A green (G) color filter is provided at the position corresponding to the pixel electrode PX of the second pixel PixG. A blue (B) color filter is provided at the position corresponding to the pixel electrode PX of the third pixel PixB.

The array substrate 2 and the counter substrate 3 are disposed facing each other with a predetermined space (cell gap) interposed therebetween. The space between the first substrate 21 and the second substrate 31 is provided with a liquid crystal layer 6 serving as a display function layer. The liquid crystal layer 6 modulates light passing therethrough by changing the orientation state of liquid crystal molecules for each pixel Pix depending on the state of the electric field between each pixel electrode PX and the common electrode COML. The liquid crystals according to the present embodiment are, for example, liquid crystals suitable for the lateral electric field mode, such as in-plane switching (IPS) including fringe field switching (FFS).

The array substrate 2 includes the pixel transistors Tr of the respective pixels Pix, and wiring, such as the gate lines SCL that supply the gate signals GATE for driving the pixel transistors Tr, and the signal lines DTL that supply the pixel signals SIG to the pixel electrodes PX. The gate lines SCL extend in the Dx direction (first direction) on a plane parallel to the surface of the first substrate 21. The signal lines DTL extend in the Dy direction (second direction) on a plane parallel to the surface of the first substrate 21.

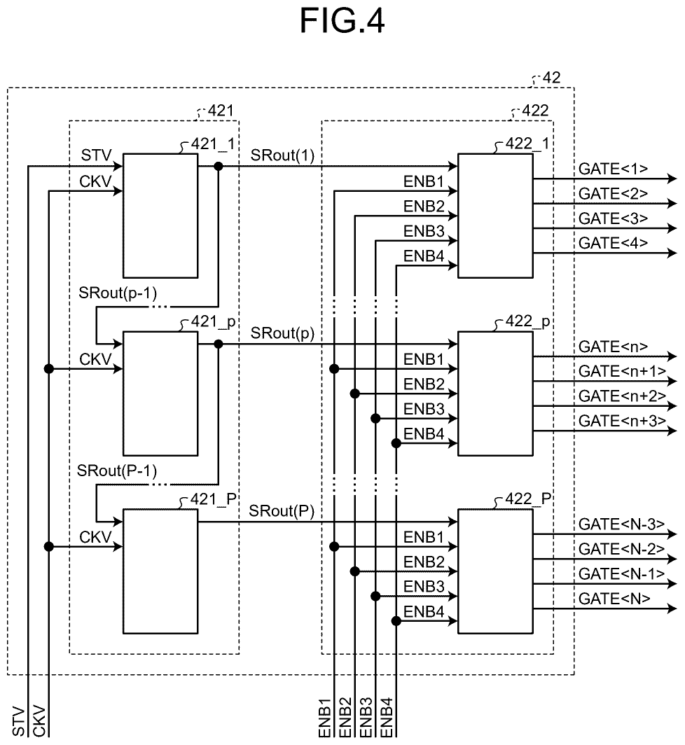

FIG. 4 is a block diagram of an exemplary configuration of the gate driver. As illustrated in FIG. 4, the gate driver 42 includes a shift register circuit 421 and a gate line drive circuit 422.

The gate line drive circuit 422 is a circuit that generates the gate signal GATE to be supplied to the gates of the pixel transistors Tr based on an output signal SRout output from the shift register circuit 421 and an enable signal ENB output from the display control circuit 44. The gate line drive circuit 422 includes gate line drive circuits 422_1, . . . , 422_p, . . . , and 422_P. The shift register circuit 421 includes shift register circuits 421_1, . . . , 421_p, . . . , and 421_P.

In the configuration example illustrated in FIG. 4, the total number P of gate line drive circuits 422 corresponds to ¼ of the total number N of pixels Pix arrayed in the Dy direction (second direction) (P×4=N). The gate line drive circuit 422_p (p is a natural number from 1 to P) is a circuit that drives four gate lines SCL continuously arrayed in the Dy direction (second direction). Specifically, the gate line drive circuit 422_1 supplies gate signals GATE<1>, GATE<2>, GATE<3>, and GATE<4>. The gate line drive circuit 422_p supplies gate signals GATE<n>, GATE<n+1>, GATE<n+2>, and GATE<n+3>. The gate line drive circuit 422_P supplies gate signals GATE<N−3>, GATE<N−2>, GATE<N−1>, and GATE<N>. The number of gate lines SCL to which the gate line drive circuit 422_p supplies the gate signals GATE is not limited to four. If the number of gate lines SCL to which the gate line drive circuit 422_p supplies the gate signals GATE is Q, the total number P of gate line drive circuits 422 corresponds to 1/Q of the total number N of pixels Pix arrayed in the Dy direction (second direction) (P×Q=N).

In the configuration example illustrated in FIG. 4, the shift register circuits 421_1, . . . , 421_p, . . . , and 421_P are provided corresponding to the gate line drive circuits 422_1, . . . , 422_p, . . . , and 422_P, respectively. Specifically, the output signal SRout(1) of the shift register circuit 421_1 is supplied to the gate line drive circuit 422_1, the output signal SRout(p) of the shift register circuit 421_p is supplied to the gate line drive circuit 422_p, and the output signal SRout(P) of the shift register circuit 421_P is supplied to the gate line drive circuit 422_P.

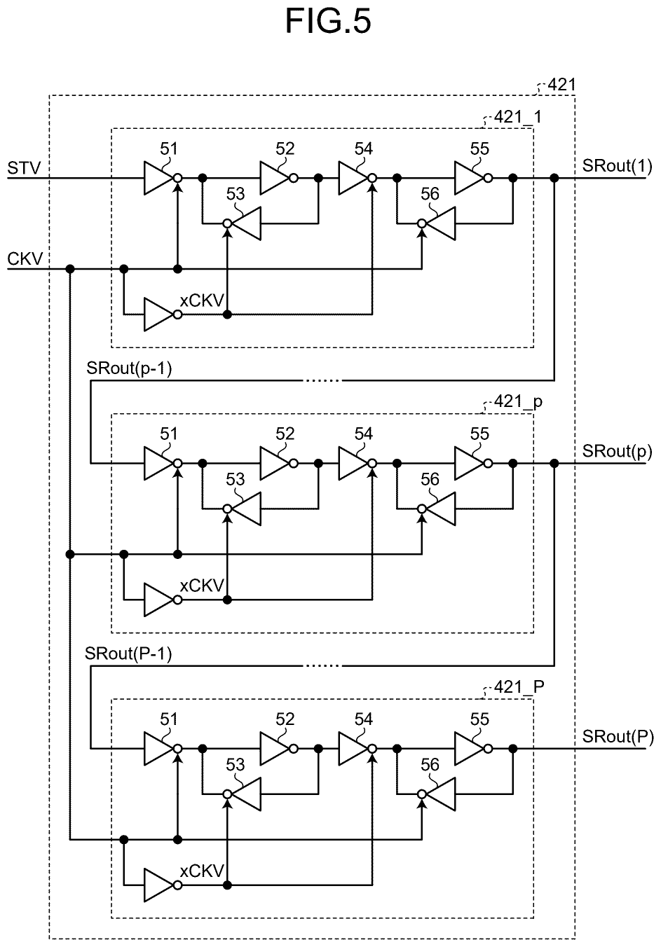

FIG. 5 is a circuit diagram of an example of the circuit configuration of the shift register circuit. The shift register circuit 421 is supplied with a start pulse signal STV and a shift clock signal CKV from the display control circuit 44.

The start pulse signal STV and the shift clock signal CKV are binary logic signals with high and low potentials.

The start pulse signal STV is a signal that defines one frame period 1F of the display device 1. Specifically, one frame period 1F of the display device 1 according to the embodiment is defined using the rising edge in the start pulse signal STV as the starting point. In other words, one frame period 1F is a period in which the image signals Vsig of one frame are displayed.

The shift clock signal CKV is a signal logically inverted in a predetermined period. More specifically, the shift clock signal CKV is a signal that transitions from the low potential to the high potential by defining the high potential period of the start pulse signal STV as one period.

The shift register circuit 421_1 receives the start pulse signal STV and the shift clock signal CKV. The shift register circuit 421_p receives an output signal SROUT(p−1) of the shift register circuit 421_p−1 (not illustrated) in the previous stage instead of the start pulse signal STV. The shift register circuit 421_P receives an output signal SROUT(P−1) of the shift register circuit 421_P−1 (not illustrated) in the previous stage instead of the start pulse signal STV.

The shift register circuits 421_1, . . . , 421_p, . . . , and 421_P each include clocked inverters 51, 53, 54, and 56, and inverters 52 and 55. The shift register circuits 421_1, . . . , 421_p, . . . , and 421_P each generate an inverted shift clock signal xCKV by logically inverting the shift clock signal CKV.

When the shift clock signal CKV is at a high potential, and the inverted shift clock signal xCKV is at a low potential, the clocked inverters 51 and 56 are turned on, and the clocked inverters 53 and 54 are turned off. When the start pulse signal STV (or the output signal SROUT(p−1) of the shift register circuit 421_p−1 (not illustrated) in the previous stage) is at a high potential, the high potential is held as the output potential of the inverter 52.

In this state, when the shift clock signal CKV is at a low potential, and the inverted shift clock signal xCKV is at a high potential, the clocked inverters 51 and 56 are turned off, and the clocked inverters 53 and 54 are turned on. As a result, the high potential held as the output potential of the inverter 52 serves as the output potential of the output signal SRout(p).

When the shift clock signal CKV is at a high potential, and the inverted shift clock signal xCKV is at a low potential, the clocked inverters 51 and 56 are turned on, and the clocked inverters 53 and 54 are turned off. When the start pulse signal STV (or the output signal SROUT(p−1) of the shift register circuit 421_p−1 (not illustrated) in the previous stage) is at a low potential, the low potential is held as the output potential of the inverter 52.

In this state, when the shift clock signal CKV is at a low potential, and the inverted shift clock signal xCKV is at a high potential, the clocked inverters 51 and 56 are turned off, and the clocked inverters 53 and 54 are turned on. As a result, the low potential held as the output potential of the inverter 52 serves as the output potential of the output signal SRout(p).

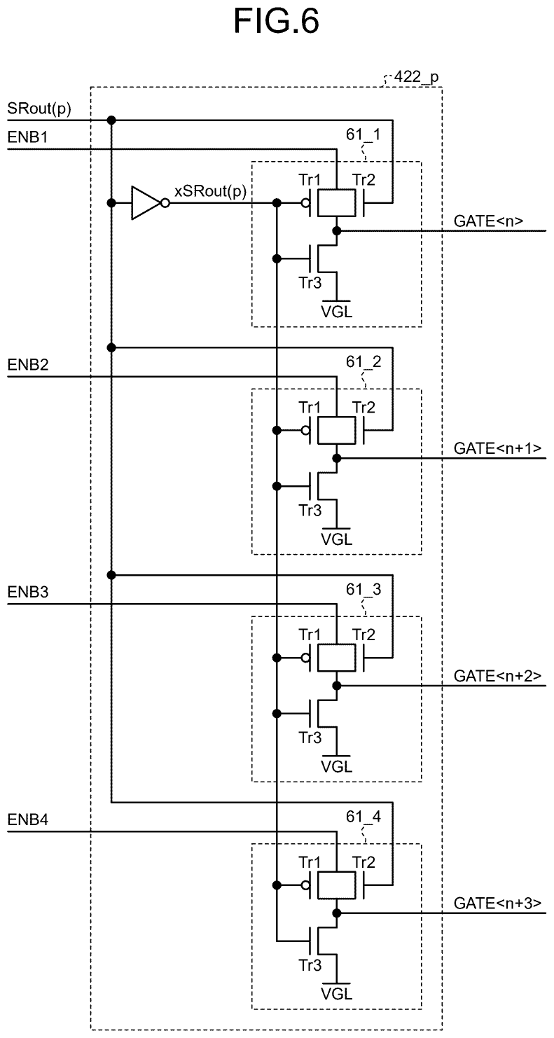

FIG. 6 is a circuit diagram of an example of the circuit configuration of the gate line drive circuit. The gate line drive circuit 422 is supplied with a first enable signal ENB1, a second enable signal ENB2, a third enable signal ENB3, and a fourth enable signal ENB4 from the display control circuit 44.

The gate line drive circuit 422_1 receives the output signal SRout(1) of the shift register circuit 421_1. The gate line drive circuit 422_p receives the output signal SRout(p) of the shift register circuit 421_p. The gate line drive circuit 422_P receives the output signal SRout(P) of the shift register circuit 421_P.

The following describes the configuration of the gate line drive circuit 422_p. The gate line drive circuit 422_p generates an inverted output signal xSRout(p) by logically inverting the output signal SRout(p) output from the shift register circuit 421_p.

The gate line drive circuit 422_p includes a first buffer circuit 61_1, a second buffer circuit 61_2, a third buffer circuit 61_3, and a fourth buffer circuit 61_4. The first buffer circuit 61_1 generates the gate signal GATE<n> to be supplied to the pixels Pix arrayed in the Dx direction (first direction) in the n-th row in the Dy direction (second direction). The second buffer circuit 61_2 generates the gate signal GATE<n+1> to be supplied to the pixels Pix arrayed in the Dx direction (first direction) in the n+1-th row in the Dy direction (second direction). The third buffer circuit 61_3 generates the gate signal GATE<n+2> to be supplied to the pixels Pix arrayed in the Dx direction (first direction) in the n+2-th row in the Dy direction (second direction). The fourth buffer circuit 61_4 generates the gate signal GATE<n+3> to be supplied to the pixels Pix arrayed in the Dx direction (first direction) in the n+3-th row in the Dy direction (second direction).

In the first buffer circuit 61_1, when the output signal SRout(p) output from the shift register circuit 421_p is at a low potential (first potential VGL), a first transistor Tr1 and a second transistor Tr2 are controlled off, and a third transistor Tr3 is controlled on. As a result, the output potential of the first buffer circuit 61_1 is the first potential VGL, and the pixel transistors Tr of the pixels Pix arrayed in the Dx direction (first direction) in the n-th row in the Dy direction (second direction) are controlled off.

In the first buffer circuit 61_1, when the output signal SRout(p) output from the shift register circuit 421_p is at a high potential (second potential VGH), the first transistor Tr1 and the second transistor Tr2 are controlled on, and the third transistor Tr3 is controlled off. As a result, the output potential of the first buffer circuit 61_1 is a potential (e.g., the second potential VGH) dependent on the potential of the first enable signal ENB1, and the pixel transistors Tr of the pixels Pix arrayed in the Dx direction (first direction) in the n-th row in the Dy direction (second direction) are controlled on.

In the second buffer circuit 61_2, when the output signal SRout(p) output from the shift register circuit 421_p is at a low potential (first potential VGL), the first transistor Tr1 and the second transistor Tr2 are controlled off, and the third transistor Tr3 is controlled on. As a result, the output potential of the second buffer circuit 61_2 is the first potential VGL, and the pixel transistors Tr of the pixels Pix arrayed in the Dx direction (first direction) in the n+1-th row in the Dy direction (second direction) are controlled off.

In the second buffer circuit 61_2, when the output signal SRout(p) output from the shift register circuit 421_p is at a high potential (second potential VGH), the first transistor Tr1 and the second transistor Tr2 are controlled on, and the third transistor Tr3 is controlled off. As a result, the output potential of the second buffer circuit 61_2 is a potential (e.g., the second potential VGH) dependent on the potential of the second enable signal ENB2, and the pixel transistors Tr of the pixels Pix arrayed in the Dx direction (first direction) in the n+1-th row in the Dy direction (second direction) are controlled on.

In the third buffer circuit 61_3, when the output signal SRout(p) output from the shift register circuit 421_p is at a low potential (first potential VGL), the first transistor Tr1 and the second transistor Tr2 are controlled off, and the third transistor Tr3 is controlled on. As a result, the output potential of the third buffer circuit 61_3 is the first potential VGL, and the pixel transistors Tr of the pixels Pix arrayed in the Dx direction (first direction) in the n+2-th row in the Dy direction (second direction) are controlled off.

In the third buffer circuit 61_3, when the output signal SRout(p) output from the shift register circuit 421_p is at a high potential (second potential VGH), the first transistor Tr1 and the second transistor Tr2 are controlled on, and the third transistor Tr3 is controlled off. As a result, the output potential of the third buffer circuit 61_3 is a potential (e.g., the second potential VGH) dependent on the potential of the third enable signal ENB3, and the pixel transistors Tr of the pixels Pix arrayed in the Dx direction (first direction) in the n+2-th row in the Dy direction (second direction) are controlled on.

In the fourth buffer circuit 61_4, when the output signal SRout(p) output from the shift register circuit 421_p is at a low potential (first potential VGL), the first transistor Tr1 and the second transistor Tr2 are controlled off, and the third transistor Tr3 is controlled on. As a result, the output potential of the fourth buffer circuit 61_4 is the first potential VGL, and the pixel transistors Tr of the pixels Pix arrayed in the Dx direction (first direction) in the n+3-th row in the Dy direction (second direction) are controlled off.

In the fourth buffer circuit 61_4, when the output signal SRout(p) output from the shift register circuit 421_p is at a high potential (second potential VGH), the first transistor Tr1 and the second transistor Tr2 are controlled on, and the third transistor Tr3 is controlled off. As a result, the output potential of the fourth buffer circuit 61_4 is a potential (e.g., the second potential VGH) dependent on the potential of the fourth enable signal ENB4, and the pixel transistors Tr of the pixels Pix arrayed in the Dx direction (first direction) in the n+3-th row in the Dy direction (second direction) are controlled on.

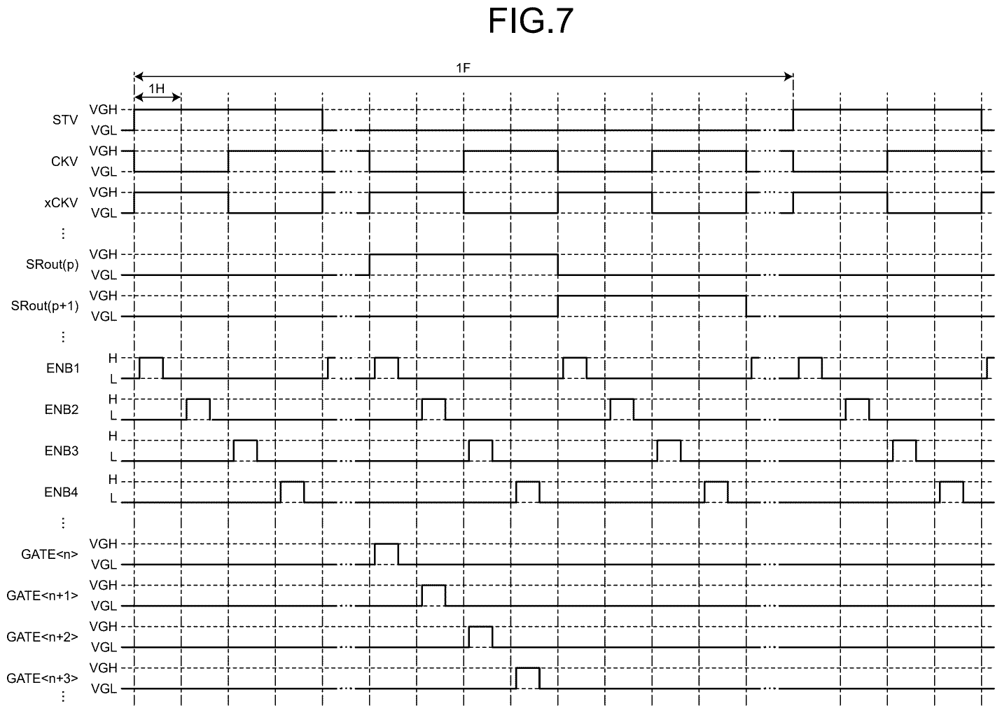

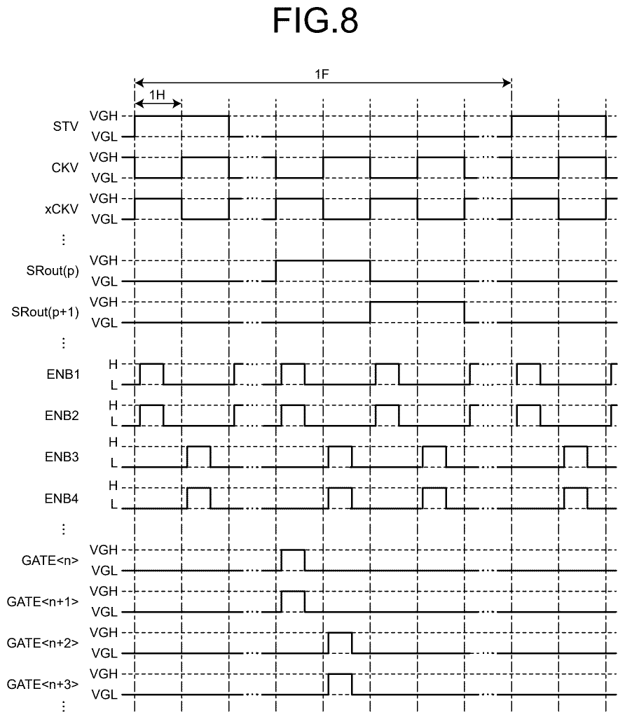

FIG. 7 is a timing chart of a first drive example of the display device according to the embodiment. FIG. 8 is a timing chart of a second drive example of the display device according to the embodiment.

In the first drive example illustrated in FIG. 7, the pixels Pix coupled to the gate lines SCL arrayed in the Dy direction (second direction) are sequentially driven in the respective horizontal periods 1H. In the second drive example illustrated in FIG. 8, the pixels Pix coupled to two gate lines SCL adjacently arrayed in the Dy direction (second direction) are simultaneously driven in one horizontal period 1H.

More specifically, in FIG. 8, in the first horizontal period of the two horizontal periods in which the output signal SRout(p) output from the shift register circuit 421_p is at a high potential (second potential VGH), the gate signal GATE<n> and the gate signal GATE<n+1> are simultaneously turned from a low potential (first potential VGL) to a high potential (second potential VGH). As a result, the pixel transistors Tr of the pixels Pix arrayed in the Dx direction (first direction) in the n-th row in the Dy direction (second direction) and the pixel transistors Tr of the pixels Pix arrayed in the Dx direction (first direction) in the n+1-th row in the Dy direction (second direction) are simultaneously controlled on.

In FIG. 8, in the first horizontal period of the two horizontal periods in which the output signal SRout(p) output from the shift register circuit 421_p is at a high potential (second potential VGH), the gate signal GATE<n> and the gate signal GATE<n+1> are simultaneously turned from a high potential (second potential VGH) to a low potential (first potential VGL). As a result, the pixel transistors Tr of the pixels Pix arrayed in the Dx direction (first direction) in the n-th row in the Dy direction (second direction) and the pixel transistors Tr of the pixels Pix arrayed in the Dx direction (first direction) in the n+1-th row in the Dy direction (second direction) are simultaneously controlled off.

In the second horizontal period of the two horizontal periods in which the output signal SRout(p) output from the shift register circuit 421_p is at a high potential (second potential VGH), the gate signal GATE<n+2> and the gate signal GATE<n+3> are simultaneously turned from a low potential (first potential VGL) to a high potential (second potential VGH). As a result, the pixel transistors Tr of the pixels Pix arrayed in the Dx direction (first direction) in the n+2-th row in the Dy direction (second direction) and the pixel transistors Tr of the pixels Pix arrayed in the Dx direction (first direction) in the n+3-th row in the Dy direction (second direction) are simultaneously controlled on.

In FIG. 8, in the second horizontal period of the two horizontal periods in which the output signal SRout(p) output from the shift register circuit 421_p is at high potential (second potential VGH), the gate signal GATE<n+2> and the gate signal GATE<n+3> are simultaneously turned from a high potential (second potential VGH) to a low potential (first potential VGL). As a result, the pixel transistors Tr of the pixels Pix arrayed in the Dx direction (first direction) in the n+2-th row in the Dy direction (second direction) and the pixel transistors Tr of the pixels Pix arrayed in the Dx direction (first direction) in the n+3-th row in the Dy direction (second direction) are simultaneously controlled off.

This configuration can achieve a higher frame rate than the first example illustrated in FIG. 7. Specifically, the frame rate in the drive mode in the second example illustrated in FIG. 8 can be approximately twice the frame rate in the first example illustrated in FIG. 7.

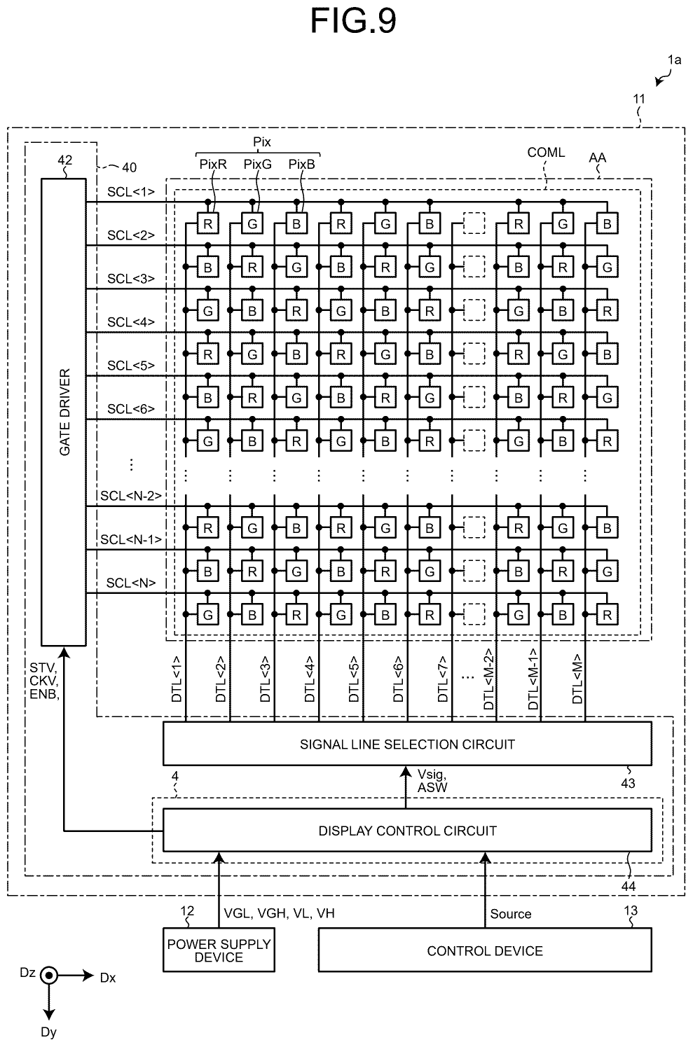

FIG. 9 is a diagram of an example of a schematic configuration of the display device according to a comparative example. The configuration of a display device 1a according to the comparative example illustrated in FIG. 9 is the same as that of the display device 1 according to the embodiment illustrated in FIG. 1 in the pixel configuration and the coupling form of the gate lines SCL<n>.

The configuration of the display device 1a according to the comparative example illustrated in FIG. 9 is different from that of the display device 1 according to the embodiment illustrated in FIG. 1 in the coupling form of the signal lines DTL<m>. Specifically, in the configuration of the display device 1a according to the comparative example illustrated in FIG. 9, the signal line DTL<m> is coupled to the pixels Pix arrayed in the m-th column of the respective rows. Therefore, the pixel signal SIG<m> is supplied to the pixels Pix arrayed in the m-th column of the respective rows via the signal line DTL<m>.

If the second drive example described above is applied to the configuration of the display device 1a according to the comparative example illustrated in FIG. 9, the same pixel signal SIG<m> is supplied to the pixels Pix that display different colors. Specifically, for example, the common pixel signal SIG is supplied to both the first pixel PixR in the first row and the first column and the third pixel PixB in the second row and the first column. Therefore, the second drive example described above is not applicable to the configuration of the display device 1a according to the comparative example illustrated in FIG. 9.

By contrast, in the configuration of the display device 1 according to the embodiment illustrated in FIG. 1, the signal line DTL<m> is coupled to the pixels Pix arrayed in the m−1-th column of the odd-numbered rows and the pixels Pix arrayed in the m-th column of the even-numbered rows as described above. As a result, the common pixel signal SIG<m> is supplied to the pixels Pix arrayed in the m−1-th column of the odd-numbered rows and the pixels Pix arrayed in the m-th column of the even-numbered rows via the signal line DTL<m> as described above.

In the configuration of the display device 1 according to the embodiment illustrated in FIG. 1, the display colors of the pixels Pix arrayed in the m−1-th column of the odd-numbered rows are the same as those of the pixels Pix arrayed in the m-th column of the even-numbered rows. Therefore, the second drive example described above can be applied. Specifically, if the second drive example described above is applied to the configuration of the display device 1 according to the embodiment illustrated in FIG. 1, the common pixel signal SIG is supplied to both the first pixel PixR in the first row and the first column and the first pixel PixR in the second row and the second column, for example.

The display device 1 is not limited to a liquid crystal display device and may be, for example, an organic EL display provided with organic light-emitting diodes (OLED) as the display elements. Alternatively, the display device 1 may be an inorganic EL display provided with inorganic light-emitting diodes (micro LED) as the display elements. Still alternatively, the display device 1 may be an electrophoretic display (EPD) or a transparent display that displays images on a transmissive display surface.

The display colors of the first pixel PixR, the second pixel PixG, and the third pixel PixB are not limited to red (R), green (G), and blue (B). For example, the display colors of the first pixel PixR, the second pixel PixG, and the third pixel PixB may be cyan (C), magenta (M), and yellow (Y).

Although the preferred embodiments of the present disclosure have been described above, the present disclosure is not limited to the embodiments described above. The content disclosed in the embodiments is merely an example, and can be variously modified within the scope not departing from the gist of the present disclosure. For example, any modifications appropriately made within the scope not departing from the gist of the present disclosure also naturally belong to the technical scope of the present disclosure.

What is claimed is:

1. A display device comprising:
a plurality of pixels arrayed in a matrix having a row-column configuration in a first direction and a second direction intersecting the first direction of a display region;
a plurality of gate lines extending in the first direction and arrayed in the second direction;
a plurality of signal lines extending in the second direction and arrayed in the first direction; and
a drive circuit configured to supply a pixel signal to the pixels via the signal lines and drive the pixels via the gate lines, wherein
when M is the total number of the pixels arrayed in ascending order from the first column to the m-th column (m is a natural number) from one end in the first direction to the other end, and N is the total number of the pixels arrayed in ascending order from the first row to the n-th row (n is a natural number) from one end in the second direction to the other end,
the total number of the gate lines is N, and the total number of the signal lines is M+1,
the n-th gate line is coupled to the pixels arrayed in the n-th row of the respective columns, and
the m-th signal line is coupled to the pixels arrayed in the m−1-th column of odd-numbered rows and the pixels arrayed in the m-th column of even-numbered rows.

2. The display device according to claim 1, wherein
the pixel in the n-th row and the m-th column and the pixel in the n-th row and the m+1-th column display different colors,
the pixel in the n-th row and the m-th column and the pixel in the n+1-th row and the m-th column display different colors, and
the pixel in the n-th row and the m-th column and the pixel in the n+1-th row and the m+1-th column display the same color.

3. The display device according to claim 2, wherein
the pixels include:
a first pixel configured to display a first color;
a second pixel configured to display a second color different from the first color; and
a third pixel configured to display a third color different from the first color and the second color.

4. The display device according to claim 3, wherein
the first pixel, the second pixel, and the third pixel are sequentially arrayed in ascending order in the first direction, and
the first pixel, the second pixel, and the third pixel are sequentially arrayed in descending order in the second direction.

5. The display device according to claim 4, wherein
the first color is red,
the second color is green, and
the third color is blue.

6. The display device according to claim 1, wherein the drive circuit sequentially drives the pixels arrayed in ascending order in the second direction.

7. The display device according to claim 1, wherein the drive circuit simultaneously drives the pixels in an odd-numbered row and the pixels in an even-numbered row adjacently arrayed in ascending order in the second direction.
